(19) United States
(12) Patent Application Publication
(10) Pub. No.: US 2025/0020851 A1
(43) Pub. Date: Jan. 16, 2025

(54) LIGHT GUIDE PLATE AND MACHINE VISION SYSTEM INCLUDING THE SAME

(71) Applicant: MEMSLUX, Daejeon (KR)

(72) Inventor: Jeong-Mu LEE, Daejeon (KR)

(21) Appl. No.: 18/768,218

(22) Filed: Jul. 10, 2024

(30) Foreign Application Priority Data
Jul. 10, 2023 (KR) 10-2023-0089187

(51) Int. Cl. F21V 8/00; H04N 23/56

(52) U.S. Cl. CPC G02B 6/0036; H04N 23/56

(57) ABSTRACT

The present disclosure relates to a light guide plate and a machine vision system including the same, and more particularly, to a light guide plate capable of removing a visual stain caused by a tolerance of light extraction patterns and generated during a manufacturing process, and a machine vision system including the same. The light guide plate according to an embodiment of the present disclosure includes: at least one side surface; and a top surface on which a plurality of light extraction patterns are formed. The plurality of light extraction patterns are randomly arranged on the top surface, the plurality of light extraction patterns are cavities having at least three different diameters and sag heights of openings, and the plurality of light extraction patterns are configured such that the sag height decreases as the diameter of the opening increases.

### CROSS-REFERENCE TO RELATED APPLICATIONS

This U.S. Non-Provisional patent application claims priority under 35 USC § 119 of Korean Patent Application No. 10-2023-0089187, filed on Jul. 10, 2023, the entire contents of which are hereby incorporated by reference herein, for all purposes.

### BACKGROUND

The present disclosure relates to a light guide plate and a machine vision system including the same, and more particularly, to a light guide plate capable of removing a visual stain caused by a tolerance of light extraction patterns and generated during a manufacturing process and a machine vision system including the same.

A light guide plate serves to uniformly distribute light incident from a light source disposed at a side surface thereof to a desired area. The distributed light heads to a specific direction.

The light guide plate has a light extraction pattern for extracting light. The light extraction pattern may be disposed on one surface of the light guide plate. When the light extraction pattern is manufactured on one surface of the light guide plate, a lithography process used in a semiconductor display process may be used.

A photomask is required for the lithography process. Although a design value of a pattern of the photomask for manufacturing the light extraction pattern is set to a predetermined specific value of 10 μm, the pattern of the substantially manufactured photomask may have a tolerance D between +0.1 μm to +1 μm depending on a grade thereof as illustrated in FIG. 1, and thus a tolerance from the design value may be firstly generated. When the generated tolerance D is within a reference tolerance range Tol that determines whether the photomask is pass or fail, the manufactured photomask is determined as a passed product although the photomask has the tolerance D. The tolerance generated as described above may be recognized as a pattern by naked eyes of a user when light is incident to the light guide plate.

Also, a drawing device that is an apparatus for manufacturing the photomask forms a pattern by scanning a laser in a unit of a line having a width of several mm on the photomask. Here, as with an arrow in FIG. 2, a tolerance is generated due to an exposure size tolerance between laser scan lines. The tolerance generated as described above may be also recognized as a pattern by the naked eyes of the user when light is incident to the light guide plate.

When the lithography process is performed, a vacuum contact method that allows the photomask contacts the substrate as close as possible may be used. The vacuum contact method is a contact method that allows the substrate and the photomask to be in a tight contact with each other by forming vacuum therebetween. During a process of performing the vacuum contact method, a portion between the substrate and the photomask is not in tight contact with each other because an air gap is formed therebetween, while another portion is in a tight contact with each other without an air gap. This non-uniform contact causes a tolerance between sizes of the finally realized light extraction patterns to be amplified. The tolerance between the sizes of the light extraction patterns may cause the finally produced light guide plate to be shown as being non-uniform to the naked eyes of the user. Specifically, FIG. 3 is a substantial photograph showing a case when light is provided to a typical light guide plate having a light extraction pattern. Referring to FIG. 3, as a tolerance in a range from 0.1 μm to 2 μm occurs in portions indicated by arrows, the portions may be recognized as stains when viewed by the naked eyes of the user. The portions are recognized as stains because the light extraction patterns are gathered and have different sizes from those of surrounding portions. The stains cause uniformity of a finally produced surface light source to be degraded.

On the other hand, the typical light guide plate generally has a specific directional angle, and this typical light guide plate generally having the specific directional angle is disadvantageous to be used as machine vision lights.

### SUMMARY

The present disclosure provides a light guide plate capable of removing a visual stain caused by a tolerance of light extraction patterns and generated during a manufacturing process and a machine vision system including the same.

The present disclosure also provides a light guide plate capable of improving visibility and a machine vision system including the same.

The present disclosure also provides a light guide plate capable of improving uniformity of a surface light source and a machine vision system including the same.

The present disclosure also provides a light guide plate capable of improving a light emission angular distribution and a machine vision system including the same.

An embodiment of the present invention provides a light guide plate including: at least one side surface; and a top surface on which a plurality of light extraction patterns are formed, in which the plurality of light extraction patterns are randomly arranged on the top surface, the plurality of light extraction patterns are cavities having at least three different diameters and sag heights of openings, and the plurality of light extraction patterns are configured such that the sag height decreases as the diameter of the opening increases.

In another embodiment of the present invention, a machine vision system including: a vision camera; a support which is disposed below the vision camera and on which an object to be inspected is disposed; and a lighting device for a machine vision, which includes a light guide plate and a light source configured to provide light to a side surface of the light guide plate and is disposed between the vision camera and the support to vertically move therebetween, in which the light guide plate includes: at least one side surface; and a top surface on which a plurality of light extraction patterns are formed, the plurality of light extraction patterns are randomly arranged on the top surface, the plurality of light extraction patterns are cavities having at least three different diameters and sag heights of openings, and the plurality of light extraction patterns are configured such that the sag height decreases as the diameter of the opening increases.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a table for explaining a reason why a tolerance D between a design value and a pattern of a substantially manufactured photomask occurs;

FIG. 2 is a photograph for explaining a reason why a tolerance occurs in a typical photomask;

FIG. 3 is a substantial photograph showing visible stains generated when light is provided to a typical light guide plate having a light extraction pattern;

FIG. 4 is a perspective view illustrating a light guide plate 100 according to an embodiment of the present invention;

FIG. 5 is an enlarged view illustrating portion A in FIG. 4;

FIG. 6 is a substantial photograph showing a light guide plate on which a light extraction pattern is formed;

FIG. 7 is a cross-sectional view taken along line B in FIG. 4;

FIG. 8 is a view for explaining an angle of reflected light and a height of a plurality of light extraction patterns of the light guide plate 100 in FIGS. 5 to 7;

FIG. 9 is a view illustrating that light emitted from a light emission surface of the light guide plate 100 in FIGS. 5 to 7 is diffused light;

FIG. 10 is a substantial photograph showing an optical effect of the light guide plate 100 in FIGS. 5 to 7, by which visible stains are not generated;

FIG. 11A is a graph showing an angular distribution of light emitted from the typical light guide plate including the light extraction patterns having the same size, and FIG. 11B is a graph showing an angular distribution of light emitted from the light guide plate 100 according to an embodiment of the present invention in FIGS. 5 to 7;

FIGS. 12A and 12B are views for explaining a machine vision system including the light guide plate 100 in FIGS. 5 to 7; and

FIG. 13 is a view for explaining a method for manufacturing the light guide plate 100 according to an embodiment of the present invention shown in FIGS. 5 to 7.

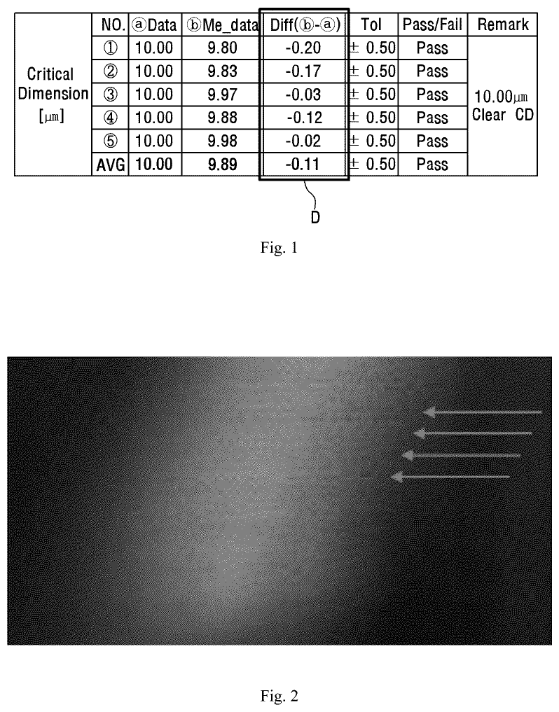

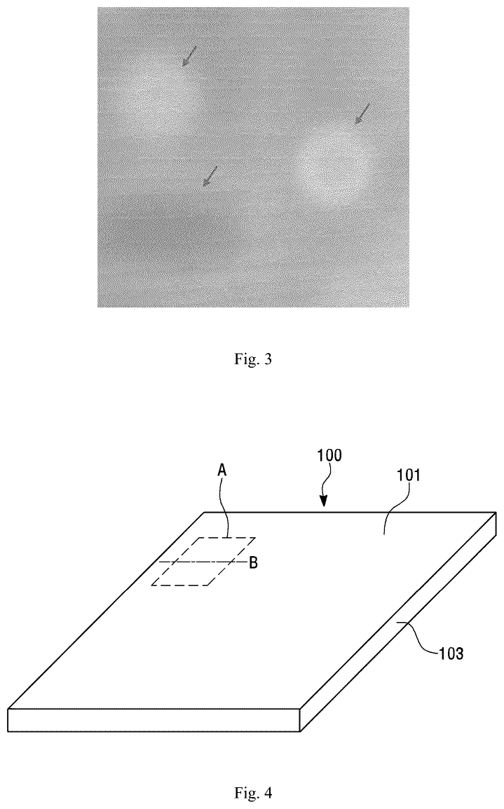

### DETAILED DESCRIPTION

Hereinafter, embodiments disclosed in this specification are described with reference to the accompanying drawings, and the same or corresponding components are given with the same drawing number regardless of reference numbers. For reference, detailed descriptions related to well-known functions or configurations will be ruled out in order not to unnecessarily obscure subject matters of the present invention.

FIG. 4 is a perspective view illustrating a light guide plate 100 according to an embodiment of the present invention.

Referring to FIG. 4, the light guide plate 100 according to an embodiment of the present invention has a top surface 101, a bottom surface (not shown), and a plurality of side surfaces 103. Here, the bottom surface (not shown) may be parallel to the top surface 101 or form an acute angle with the top surface 101.

The light guide plate 100 may be made of a transparent or translucent material such as glass, polymethylmethacrylate (PMMA), styrenemethyl methacrylate (SMMA), cyclic olefin copolymer (COC), arylite, polycarbonate, polyethyleneterephtalate (PET), polyimide (PI), polyethylene (PE), polyethersulfone (PES), polyolefin (PO), polyvinylalcohol (PVA), polyvinylchloride (PVC), triacetylcellulose (TAC), polystyrene (PS), polypropylene (PP), acrylonitrile butadiene styrene (ABS), styrene acrylonitrile (SAN/AS), polyethylene naphthalate (PEN), polytrimethylene terephthalate (PTT), polyurethane (PU), polyurethane acrylate (PUA), thermoplastic polyurethane (TPU), polyarylate (PAR), silicone, and polydimethylsiloxane (PDMS).

The light guide plate 100 may be made of a rigid or flexible material.

When the light guide plate 100 receives light through at least one of a plurality of side surfaces 103, the light guide plate 100 may emit light through one of the top surface 101 or the bottom surface (not shown).

A plurality of light extraction patterns may be disposed on one of the top surface 101 or the bottom surface (not shown) of the light guide plate 100. Hereinafter, it will be described that the plurality of light extraction patterns are disposed on the top surface 101 of the light guide plate 100 for convenience of description.

The plurality of light extraction patterns disposed on the top surface 101 of the light guide plate 100 may be cavities that are engraved patterns. The plurality of light extraction patterns may be arranged randomly on the top surface 101 of the light guide plate 100.

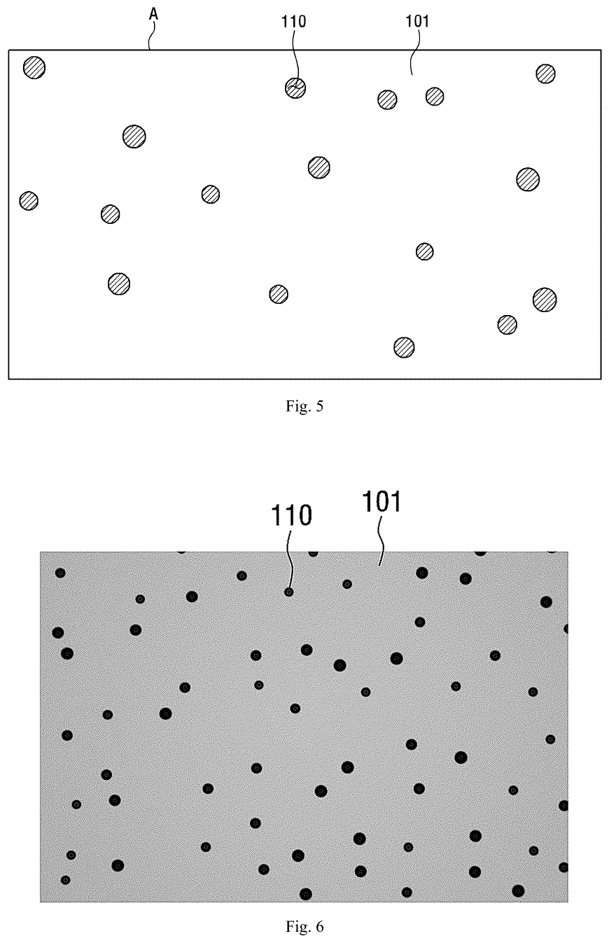

Hereinafter, the plurality of light extraction patterns disposed on the top surface 101 of the light guide plate 100 will be described with reference to FIGS. 5 and 6.

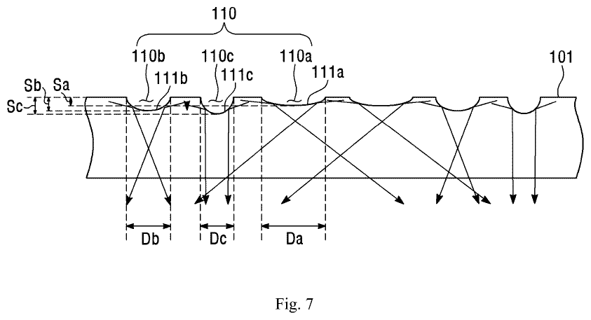

FIG. 5 is an enlarged view illustrating portion A in FIG. 4, FIG. 6 is a photograph of the light guide plate in which the light extraction patterns are formed, and FIG. 7 is a cross-sectional view taken along line B of FIG. 4.

Referring to FIGS. 5 to 7, the top surface 101 of the light guide plate 100 includes the plurality of light extraction patterns 110.

The light extraction patterns 110 are engraved patterns and have circular openings when viewed from the top surface 101. Each of the openings may have a shape having a portion of a sphere or ellipsoid shape.

The plurality of light extraction patterns 110 are arranged randomly instead of having a specific pattern.

The openings of the plurality of light extraction patterns 110 may have different diameters. Each of the openings of the plurality of light extraction patterns 110, which has a circular shape, may have a diameter of 1 μm to 50 μm, preferably a diameter of 13 μm to 17 μm.

The openings of the plurality of light extraction patterns 110 may have at least three different diameters. For example, the plurality of light extraction patterns 110 may include a first light extraction pattern 110a including an opening having a first diameter Da, a second light extraction pattern 110b including an opening having a second diameter Db, and a third light extraction pattern 110c including an opening having a third diameter Dc. Here, the first diameter Da is greater than the second diameter Db, and the second diameter Db is greater than the third diameter Dc.

The first light extraction pattern 110a has a first sag height Sa, the second light extraction pattern 110b has a second sag height Sb, and the third light extraction pattern 110c has a third sag height Sc. Here, the first sag height Sa is less than the second sag height Sb, and the second sag height Sb is less than the third sag height Sc.

The light guide plate 100 may include a first curved surface 111a that defines the first light extraction pattern 110a, a second curved surface 111b that defines the second light extraction pattern 110b, and a third curved surface 111c that defines the third light extraction pattern 110c.

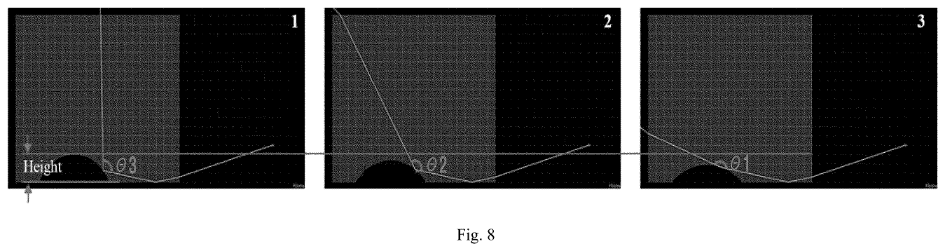

Referring to FIG. 8 in addition to FIGS. 5 to 7, among light incident to the light guide plate 100, a first reflection angle θ1 of light incident to and reflected by the first curved surface 111a is greater than a second reflection angle θ2 of light incident to and reflected by the second curved surface 111b, and the second reflection angle θ2 of the light incident to and reflected by the second curved surface 111b is greater than a third reflection angle θ3 of light incident to and reflected by the third curved surface 111c. Here, each of the first to third reflection angles θ1, 02, and 03 may be an obtuse angle.

The first to third curved surfaces 111a, 111b, and 111c define cavities of the first to third light extraction patterns 110a, 110b, and 110c, respectively. The first to third curved surfaces 111a, 111b, and 111c may be integrated with the top surface 101.

The light reflected by the first to third curved surfaces 111a, 111b, and 111c may be extracted to the outside through the bottom surface of the light guide plate 100.

The first to third light extraction patterns 110a, 110b, and 110c follow a rule in which sag heights Sa, Sb, and Sc gradually decrease as the diameters Da, Db, and Dc increase. The rule also applies to the plurality of light extraction patterns 110.

Also, the reflection angles of the light incident to and reflected by the first to third curved surfaces 111a, 111b, and 111c are inversely proportional to the sag heights Sa, Sb, and Sc and proportional to the diameters Da, Db, and Dc. The rule also applies to the plurality of light extraction patterns 110.

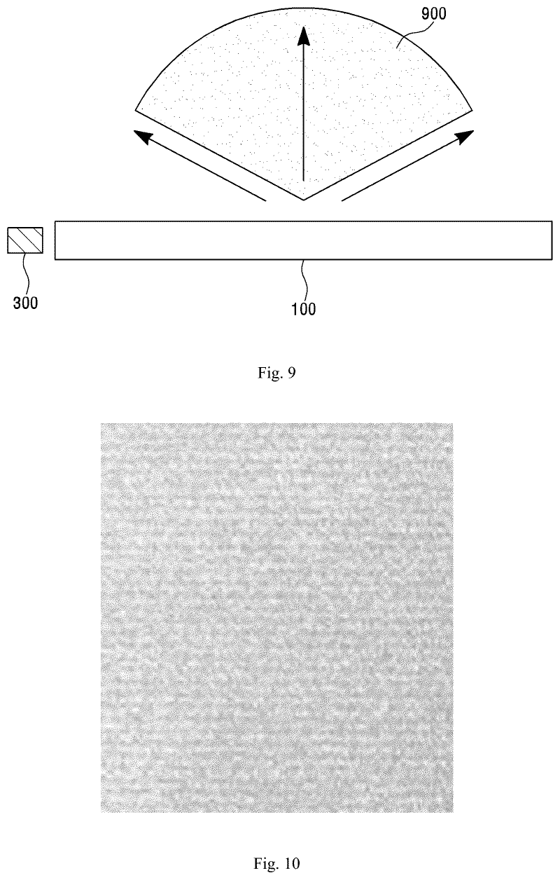

Since the light emitted through the bottom surface (or light emission surface) of the light guide plate 100 including the plurality of light extraction patterns 110 is a mixture of light reflected at various angles, the light guide plate 100 that receives light from a light source 300 may realize diffused light 900 through the light emission surface as illustrated in FIG. 9.

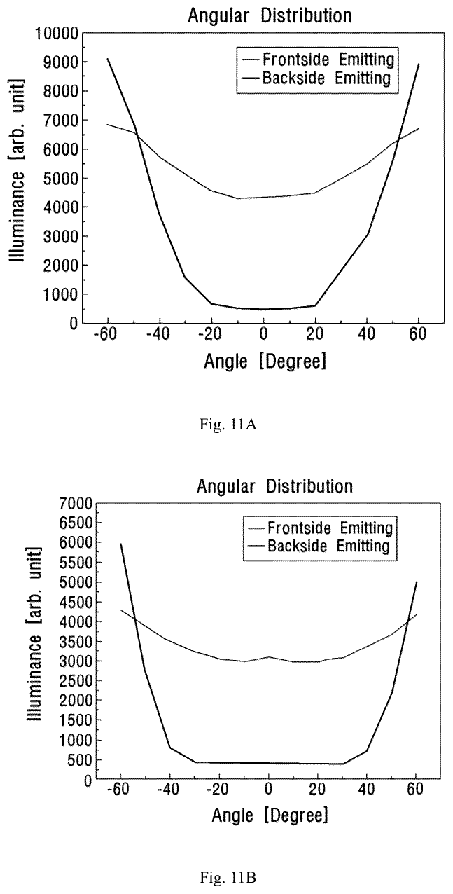

Since the light guide plate 100 in FIGS. 5 to 7 includes the plurality of light extraction patterns 110, there is an advantage in that almost no stain on the light extraction surface is recognized when viewed with naked eyes as illustrated in FIG. 10. This is caused by an arrangement type, a structure, and a shape of the above-described plurality of light extraction patterns 110.

Also, since the sags of the plurality of curved surfaces 111a, 111b, and 111c of the plurality of light extraction patterns 110 are different, there is also an advantage of having different optical characteristics.

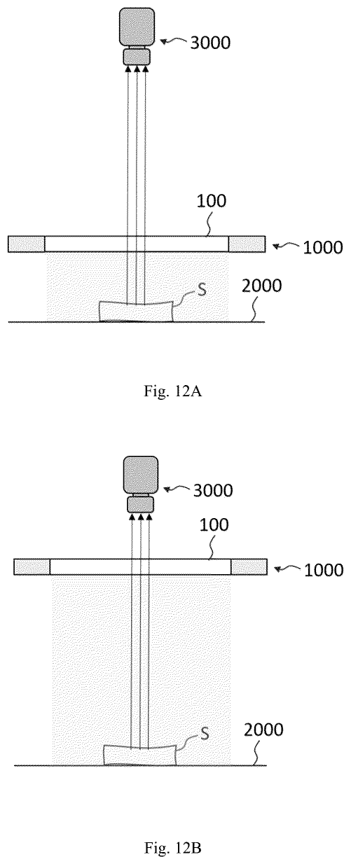

Also, the light guide plate 100 in FIGS. 5 to 7 has an advantage in that the light guide plate 100 may widen a light emission angle of light emitted through the light emission surface. The light emission angle of the light emitted through the light emission surface of the light guide plate 100 in FIGS. 5 to 7 may be widened further than a light emission angle of light emitted through a light emission surface of a typical light guide plate including light extraction patterns having the same size. This will be described with reference to FIGS. 11A and 11B.

FIG. 11A is a graph showing an angular distribution of light emitted from a typical light guide plate including light extraction patterns having the same size, and FIG. 11B is a graph showing an angular distribution of light emitted from the light guide plate 100 according to an embodiment of the present invention in FIGS. 5 to 7.

Referring to FIGS. 11A and 11B, although illuminance values of emitted light show a difference due to a difference in densities of the light extraction patterns between the typical light guide plate and the light guide plate 100 according to an embodiment of the present invention, it may be known from the angular distribution of emitted light that the light emission angles of the light guide plate 100 according to an embodiment of the present invention are spread more gently than those of the typical light guide plate.

On the other hand, the light emission angle may be adjusted by adjusting the number of different patterns of the plurality of light extraction patterns 110 of the light guide plate 100 according to an embodiment of the present invention. A designer may appropriately adjust the number of the first to third light extraction patterns 110a, 110b, and 110c to realize a target light emission angle. For example, the designer may realize the desired light emission angle by adjusting a ratio of the number of the first light extraction patterns 110a, the number of the second light extraction patterns 110b, and the number of the third light extraction patterns 110c to 1:1:8, 1:8:1, or 8:1:1.

Also, as illustrated in FIG. 9, since the light guide plate 100 may realize the diffuse light 900, the light guide plate 100 is advantageous when applied to a lighting device for a machine vision. This is because an overall shape of a front surface of an object is expressed relatively better than an edge of the object when the light guide plate that emits diffused light is applied to the lighting device for the machine vision while the edge (or border) of the object is expressed better than other portions of the object when the light guide plate that emits straight light is applied to the lighting device for the machine vision.

Also, since the light guide plate 100 in FIGS. 5 to 7 emits the diffuse light through the light emission surface, the light guide plate 100 is advantageous for realizing dome lights together with coaxial lights when applied to the lighting device for the machine vision. Hereinafter, a detailed description will be provided with reference to FIGS. 12A and 12B.

FIGS. 12A and 12B are views for explaining a machine vision system including the light guide plate 100 in FIGS. 5 to 7.

The machine vision system may include a lighting device 1000 for the machine vision, which includes the light guide plate 100 in FIGS. 5 to 7 and a light source (not shown) providing light to the light guide plate 100, a support 2000, and a vision camera 3000. The lighting device 1000 for the machine vision may be disposed between the vision camera 3000 and the support 2000 to vertically move between the vision camera 3000 and the support 2000. The vertical movement of the lighting device 1000 for the machine vision may be performed by a driving device (not shown) connected to the lighting device 1000 for the machine vision to control the vertical movement of the lighting device 1000 for the machine vision.

Here, as illustrated in FIG. 12A, when the lighting device 1000 for the machine vision is disposed relatively close to an object S to be inspected, which is disposed on the support 2000, the lighting device 1000 for the machine vision may exhibit an optical effect such as dome lights so that the vision camera 300 obtains a high-quality image of the object S to be inspected. On the other hand, as illustrated in FIG. 12B, when the lighting device 1000 for the machine vision is disposed relatively far from the object S to be inspected, the lighting device 1000 for the machine vision may exhibit an optical effect such as coaxial lights so that the vision camera 300 obtains a high-quality image of the object S to be inspected.

Since the light guide plate 100 in FIGS. 5 to 7 emits the diffused light through the light emission surface, the lighting device 1000 for the machine vision may exhibit the optical effect similar to the coaxial lights as well as the optical effect similar to the dome lights. Thus, when the lighting device 1000 for the machine vision, which includes the light guide plate 100 in FIGS. 5 to 7, there is an advantage in that one lighting device 1000 for the machine vision may adaptively adjust a distance to the object S to be inspected instead of using different lighting devices depending on relative distances from the machine vision system to the object S to be inspected.

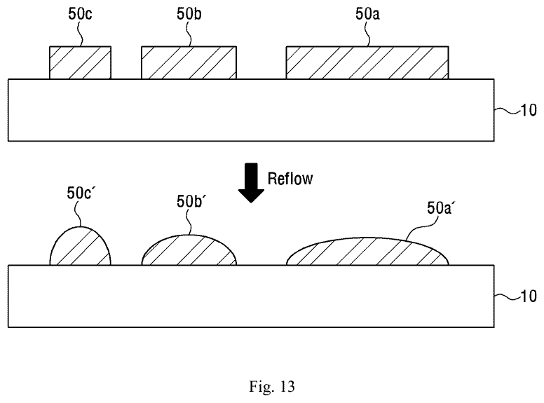

FIG. 13 is a view for explaining a method for manufacturing the light guide plate 100 in FIGS. 5 to 7 according to an embodiment of the present invention.

Referring to FIG. 13, a plurality of photoresist layers 50a, 50b, and 50c having the same thickness are formed on a base substrate 10. Here, the plurality of photoresist layers 50a, 50b and 50c have different pattern diameters. For example, a first photoresist layer 50a has a pattern diameter greater than that of a second photoresist layer 50b, and the second photoresist layer 50b has a pattern diameter greater than that of a third photoresist layer 50c.

Thereafter, a reflow process that applies heat to the plurality of photoresist layers 50a, 50b, and 50c is performed. When the reflow process is performed, the plurality of photoresist layers 50a, 50b, and 50c are melted into spherical shapes, and photoresist layers 50a′, 50b′, and 50c′ having different shapes depending on the pattern diameters of the plurality of photoresist layers 50a, 50b, and 50c are formed.

Specifically, when the first photoresist layer having a relatively longest pattern diameter is melted, the first photoresist layer 50a is spread wider due to surface tension than the rest photoresist layers 50b and 50c but has a smallest height. On the other hand, when the third photoresist layer 50c having a relatively shortest pattern diameter is melted by heat, the third photoresist layer 50c is spread narrower due to surface tension than the rest photoresist layers 50a and 50b but has a greatest height.

When a plurality of cured photoresist layers 50a′, 50b′, and 50c′ are formed through a curing process after the reflow process, a first mold (not shown) is manufactured on the base substrate 10 by forming a predetermined molding material. The manufactured first mold (not shown) has one surface in which an engraved pattern corresponding to the plurality of photoresist layers 50a′, 50b′, and 50c′ are formed.

Here, a second mold (not shown) may be manufactured by forming a predetermined molding material again on the first mold (not shown), and a third mold (not shown) may be manufactured by forming a predetermined molding material again on the second mold (not shown). Here, an embossed pattern corresponding to the engraved pattern formed on the first mold (not shown) is formed on the second mold (not shown), and an engraved pattern corresponding to the embossed pattern formed on the second mold (not shown) is formed on the third mold (not shown).

The light guide plate 100 in FIGS. 5 to 7 may be manufactured by using the first mold (not shown) or the third mold (not shown), in which the engraved pattern is formed.

According to the above-described manufacturing method, since the plurality of photoresist layers 50a, 50b, and 50c have the same thickness due to semiconductor process characteristics, sag heights of the plurality of photoresist layers 50a′, 50b′, and 50c′ after the reflow process may be varied from those illustrated in FIG. 7 when the plurality of photoresist layers 50a, 50b, and 50c have different pattern diameters.

According to the embodiment of the present invention, the visible stains, which are recognized by the naked eyes, caused by the tolerance of the light extraction patterns, and generated in the manufacturing process, may be removed.

Also, the visibility may be improved.

Also, the uniformity of the surface light source may be improved.

Also, the light emission angular distribution may be improved.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A light guide plate comprising:
at least one side surface; and
a top surface on which a plurality of light extraction patterns are formed,
wherein the plurality of light extraction patterns are randomly arranged on the top surface,
wherein the plurality of light extraction patterns are cavities having at least three different diameters and sag heights of openings, and
wherein the plurality of light extraction patterns are configured such that the sag height decreases as the diameter of the opening increases.

2. The light guide plate of claim 1, further comprising a plurality of curved surfaces that define the cavities of the plurality of light extraction patterns, respectively,
wherein the plurality of curved surfaces reflect light incident through the side surfaces at three or more different reflection angles, and
wherein the reflection angles of the plurality of curved surfaces are inversely proportional to the sag heights and proportional to the diameters of the openings.

3. The light guide plate of claim 2, wherein each of the reflection angles of the plurality of curved surfaces is an obtuse angle.

4. The light guide plate of claim 1, wherein each of the openings of the light extraction patterns has a circular shape.

5. The light guide plate of claim 4, wherein the opening has a diameter of 13μ m to 17μ m.

6. The light guide plate of claim 1, further comprising a bottom surface through which light incident to the side surfaces and reflected by the plurality of light extraction patterns is emitted,
wherein the light emitted through the bottom surface is diffused light.

7. A machine vision system comprising:
a vision camera;
a support which is disposed below the vision camera and on which an object to be inspected is disposed; and
a lighting device for a machine vision, which comprises a light guide plate and a light source configured to provide light to a side surface of the light guide plate and is disposed between the vision camera and the support to vertically move therebetween,
wherein the light guide plate comprises:
at least one side surface; and
a top surface on which a plurality of light extraction patterns are formed,
wherein the plurality of light extraction patterns are randomly arranged on the top surface,
wherein the plurality of light extraction patterns are cavities having at least three different diameters and sag heights of openings, and
wherein the plurality of light extraction patterns are configured such that the sag height decreases as the diameter of the opening increases.

8. The machine vision system of claim 7, further comprising a plurality of curved surfaces that define the cavities of the plurality of light extraction patterns, respectively,
wherein the plurality of curved surfaces reflect light incident through the side surfaces at three or more reflection angles, and
wherein the reflection angles of the plurality of curved surfaces are inversely proportional to the sag heights and proportional to the diameters of the openings.

9. The machine vision system of claim 8, wherein each of the reflection angles of the plurality of curved surfaces is an obtuse angle.

10. The machine vision system of claim 7, wherein each of the openings of the system extraction patterns has a circular shape.

11. The machine vision system of claim 10, wherein the opening has a diameter of 13 μm to 17 μm.

12. The machine vision system of claim 7, further comprising a bottom surface through which light incident to the side surfaces and reflected by the plurality of light extraction patterns is emitted,
wherein the light emitted through the bottom surface is diffused light.
